(19) United States
(12) Patent Application Publication
(10) Pub. No.: US 2010/0285438 A1
(43) Pub. Date: Nov. 11, 2010

(54) Method And System For Minimally-Invasive Surgery Training

(76) Inventors: Thenkurussi Kesavadas, Clarence Center, NY (US); Khurshid Guru, East Amherst, NY (US); Govindarajan Srimathveeravalli, Buffalo, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/723,579

(22) Filed: Mar. 12, 2010

Related U.S. Application Data
(60) Provisional application No. 61/159,629, filed on Mar. 12, 2009.
(60) Provisional application No. 61/245,111, filed on Sep. 23, 2009.

(51) Int. Cl. G09B 23/28

(52) U.S. Cl. 434/262

(57) ABSTRACT

The present invention may be embodied as a method of minimally-invasive surgery (“MIS”) training wherein a simulator having a display, a computer, and a first input device, is provided. A video of an MIS is displayed on the display, and a first surgical tool is visible in at least a portion of the video. A match zone corresponding to a position on the first surgical tool is determined. A computer-generated virtual surgical tool (“CG tool”) is superimposed on the displayed video. The CG tool is selectively controlled by the first input device. A target position of the CG tool is determined. If the target position is not determined to be within the match zone, further steps may be taken. For example, the video may be paused, a message may be displayed to the operator, or the computer may signal the input device to move to a position such that the target position is within the match zone.

### CROSS-REFERENCE TO RELATED APPLICATION

This application claims the benefit of priority to U.S. provisional patent application Ser. No. 61/159,629, filed on Mar. 12, 2009, now pending, and U.S. provisional patent application Ser. No. 61/245,111, filed on Sep. 23, 2009, now pending, the disclosures of which are incorporated herein by reference.

### FIELD OF THE INVENTION

The invention relates to surgical training, and more particularly to training a person in performing minimally-invasive surgical procedures.

### BACKGROUND OF THE INVENTION

Minimally invasive surgery (“MIS”) has been accepted as a useful alternative to open surgery for many health conditions. While safer for the patient, MIS poses a number of unique challenges to the surgeon performing them. The challenges fall into two broad domains: (i) the cognitive domain, wherein the surgeon uses knowledge and prior experience to make decisions regarding the procedure; and (ii) the motor control domain, where the surgeon uses physical skills to carry out specific decisions made through their cognitive process. For example, in laparoscopic surgery, a type of MIS, the surgery is conducted through small incisions made in the thorax or the abdomen of the body. Since the surgery takes place inside the closed volume of the human body, a small flexible camera called an endoscope is inserted inside the body to provide visual feedback. This set up gives rise to a number of cognitive challenges that make this form of surgery especially challenging, including:

(1) lack of visual feedback—the visual feedback is provided by images captured through the endoscope and displayed on a screen, lacking depth information;

(2) poor image quality—since the procedure is carried out within closed body cavities, the images received from the endoscope is affected by a number of factors, including improper lighting, smoke from cauterization of tissue and lensing effects;

(3) landmarks—Unlike open surgery, anatomical landmarks are not readily discernible and it is difficult to get oriented and navigate correctly inside the body without making mistakes; and

(4) patient differences—pathology and individual variations in physiology create visual differences in two bodies, this effect is amplified in MIS.

Some ramifications of the above described problems result in making the cognitive process of the surgeons exceedingly difficult. It is for the same reasons residents require extensive training with a number of procedures before they can graduate to performing surgery on their own.

Currently available simulators may train surgical residents for motor skill improvement. However, the current training methods do not adequately address the issue of improving the cognitive ability of the resident. Therefore, a resident typically gets acquainted with identifying anatomical landmarks by watching actual surgeries and training under a surgeon. This makes the learning curve slow, difficult, and expensive.

Accordingly, there is a need for an MIS training method and system that better prepares the operator by improving both the motor skills and the cognitive skills of the trainer.

### BRIEF SUMMARY OF THE INVENTION

The currently disclosed cognitive skills training method and simulator may be used to teach the steps of a surgical procedure by enabling an operator to execute surgical steps in a virtual environment. A method and system according to the present invention may offer feedback including corrective instructions that can be demonstrated by, for example, supplying text, video, audio, and/or corrective force feedback.

The present invention may be embodied as a method of minimally-invasive surgery training wherein a simulator having a display, a computer, and a first input device, is provided. A video of a minimally-invasive surgery is displayed on the display. The video may be pre-recorded or the video may be a real-time feed from an MIS. The video may be a stereoscopic video. The video may include metadata related to the video, the MIS, or the surgical environment.

A first surgical tool is visible in at least a portion of the video. A match zone corresponding to a position on the first surgical tool is determined. The match zone may be determined in two or three dimensions.

A computer-generated virtual surgical tool (a “CG tool”) is superimposed on the displayed video. The CG tool is selectively controlled by the first input device. A target position of the CG tool is determined. The target position of the CG tool corresponds to the determined match zone of the first surgical tool. The target position may be determined in two or three dimensions.

A determination may be made whether the target position of the CG tool is within the match zone of the first surgical tool. If the target position is not within the match zone, further steps may be taken. For example, the video may be paused, a message may be displayed to the operator, or the computer may signal the input device to move to a position such that the target position is within the match zone.

The location of an entry point, known as a “trocar,” of the first surgical tool may be calculated, and a vector of the first surgical tool may be determined. The vector of the first surgical tool may be compared to a determined vector of the CG tool. The entry point and vectors may be determined in two or three dimensions.

In another embodiment of the present invention, the first virtual tool may include an end-effector, which may require activation. The CG tool may have a similar end-effector able to be activated by the operator. A method according to an embodiment of the present invention may cause any of the further steps (e.g., pausing the video, moving the first input device) to be taken if the status of the end-effector of the CG tool does not match the status of the end-effector the first surgical tool.

In another embodiment, the video may be interactive such that the point-of-view of the video may be changed by the operator. Also, the camera movements of the camera used to capture the video may be tracked. These tracked camera movements may be used to generate prompts for the operator to change the point-of-view of the video. Additional steps may be taken if the movement of the point-of-view does not substantially match the movement of the camera.

The invention may be embodied as an MIS simulator having a computer, a display in communication with the computer, and a first input device in communication with the computer. The computer is programmed to perform any of the methods described above.

A clutch may be provided which may cause the CG tool to be “disconnected” from the first input device when the clutch is activated. In this case, movement of the first input device no longer causes a movement of the CG tool, and the position of the first input device relative to the CG tool may be changed by the operator.

In another embodiment according to the present invention, a second surgical tool may be visible in at least a portion of the video. The second surgical tool may be selectively controlled by the first input device or a second input device. A match zone of the second surgical tool may be determined—the second match zone—corresponding to a position on the second surgical tool. A second CG tool may be superimposed on the displayed video, and the second CG tool may have a second target position.

### DESCRIPTION OF THE DRAWINGS

For a fuller understanding of the nature and objects of the invention, reference should be made to the following detailed description taken in conjunction with the accompanying drawings, in which:

FIG. 1a is a front view of an MIS simulator system according to an embodiment of the present invention;

FIG. 1b is a perspective view of the MIS simulator of FIG. 1a;

FIG. 2 depicts a displayed video according to an embodiment of the present invention wherein the position of a target position is shown within a first match zone;

FIG. 3 depicts the displayed video of FIG. 2 wherein the position of the target position is shown not to be within the first match zone;

FIG. 4 depicts a displayed video according to another embodiment of the present invention; and

FIG. 5 is a flowchart depicting several methods according to the present invention.

### DETAILED DESCRIPTION OF THE INVENTION

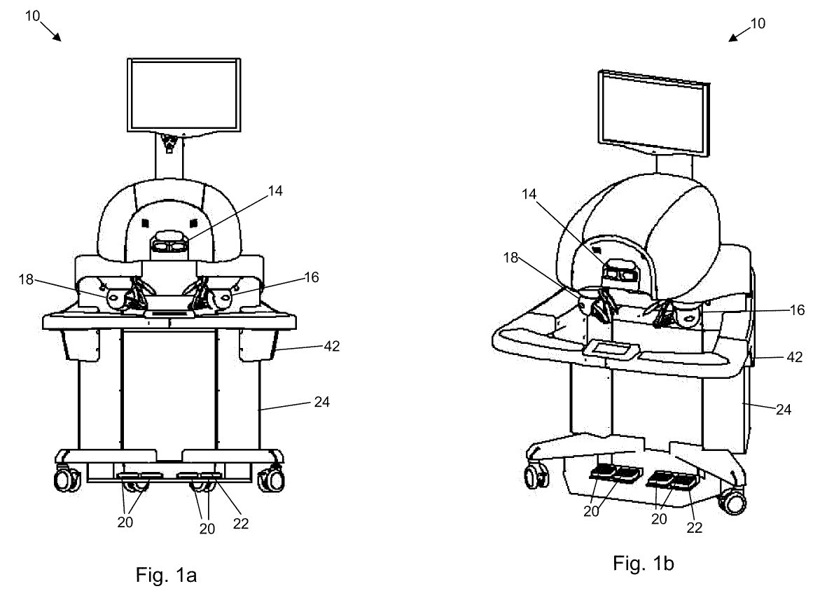

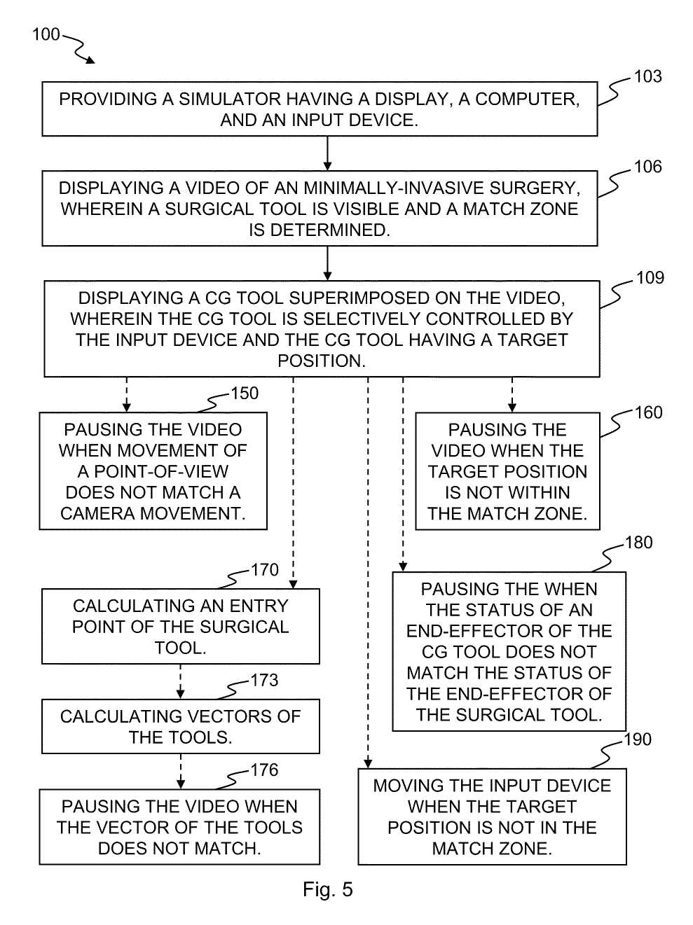

The present invention may be embodied as a method 100 of minimally-invasive surgery (“MIS”) training (see FIG. 5). A simulator 10 is provided 103, the simulator 10 having a display 14, a computer 24, and a first input device 16. The first input device 16 may be selected to best recreate the motion of an actual surgical device. In a non-limiting example, a six degree-of-freedom device (such as a Phantom Omni®) may be selected as the first input device 16 to recreate the motion an input of a da Vinci® Surgical System (“DVSS”). One example of a suitable simulator 10, the Robotic Surgical Simulator (“RoSS™”) from Simulated Surgical Systems LLC is depicted in FIG. 1, although it should be understood that other simulators may be used.

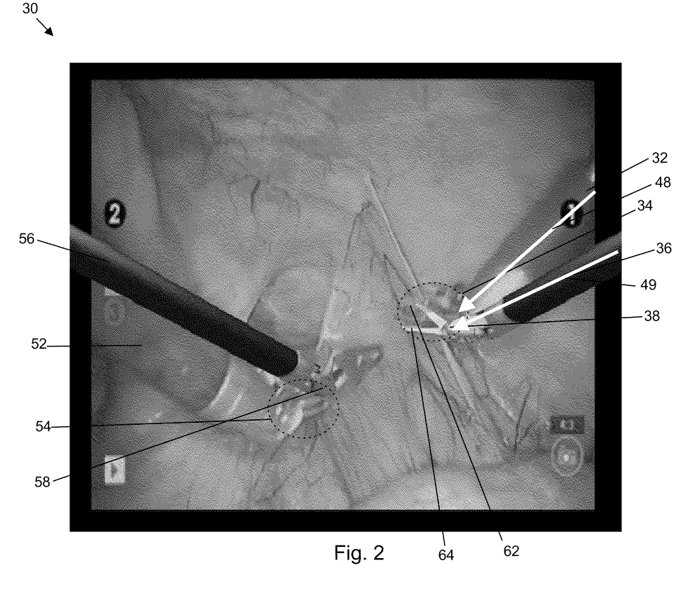

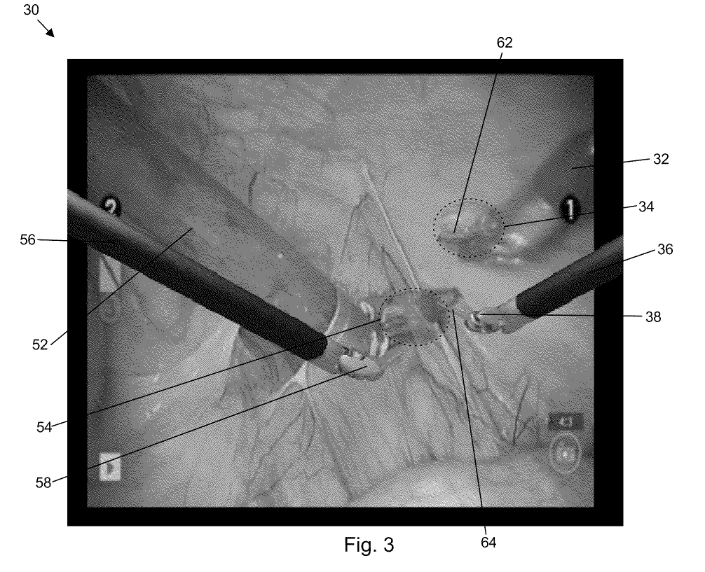

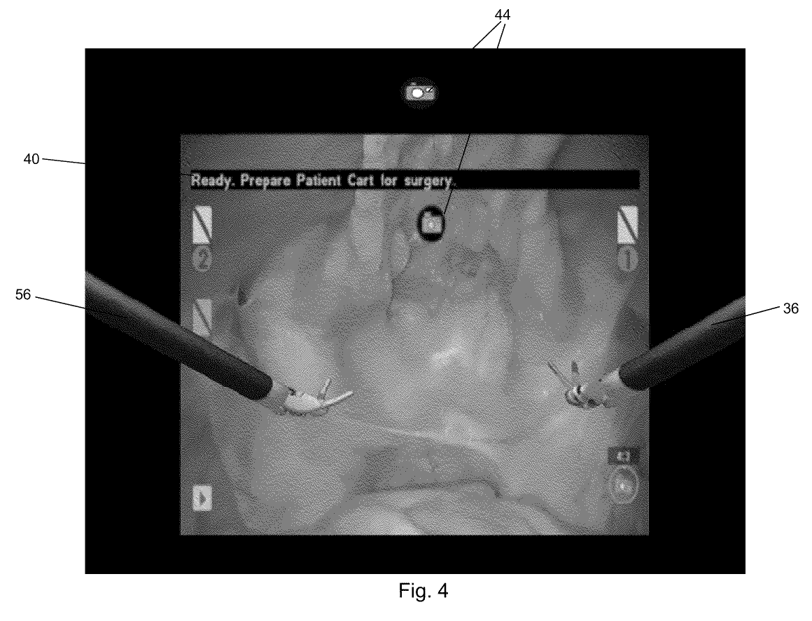

A video 30 of an MIS is displayed 106 on the display 14. The video 30 shows an MIS in progress and a first surgical tool 32 is visible in at least a portion of the video 30 (see, e.g., FIGS. 2 and 3). In one example, the video 30 may show a prostatectomy using a DVSS, where one of the robot's tools is visible. Such tools may include, but are not limited to, a scalpel, scissors, or bovie. In another example, the video may show a conventional (non-robotic) laparoscopic procedure. Other videos of suitable MIS procedures will be apparent to those having skill in the art.

The video 30 may be pre-recorded by a surgeon and/or operating room staff during a surgical procedure. Alternatively, the video 30 may be a video from a surgical procedure being performed at the same time as the MIS training according to the present invention—a “live feed.”

The video 30 may be a stereoscopic video, captured from two points-of-view in fixed relation to each other. As such, an operator is able to view the video 30 as a three-dimensional video. In this case, the display 14 may also be a stereoscopic display capable of displaying the stereoscopic video. The three-dimensional representation is constructed from two two-dimensional images/videos. This type of three-dimensional construction is often referred to as 2.5-dimensional (two-and-a-half dimensional). Three dimensional and 2.5 dimensional will be used interchangeably in this disclosure.

A match zone 34 of the first surgical tool 32 is determined. The match zone 34 corresponds to a position on the first surgical tool 32. In a non-limiting example, the match zone 34 may correspond to a point on end of the first surgical tool 32. The match zone 34 may also include a margin around a determined point such that the match zone 34 includes, for example, but not limited to, a one-inch radius around the point on the end of the first surgical tool 32. By determining the match zone 34 corresponding to a position on the tool, the match zone 34 will move with the tool. The computer 24 may analyze the video 30 and determine where the match zone 34 is within the video space. For example, if the first surgical tool 32 is seen in the video 30 to move from the lower right of the video space to the upper left, the computer 24 will determine the corresponding movement of the match zone 34 from the lower right to the upper left.

The match zone 34 may be determined in two dimensions. In this case, the match zone 34 may be configured as a circle around a point on the surgical tool 32. Alternatively, in the case of a stereoscopic video, the match zone 34 may be determined in three dimensions. In this case, the match zone 34 may be configured as a sphere around a point on the surgical tool 32. Other, less-regular shapes may be chosen as suitable for the particular task and tool. For example, a three-dimensional match zone 34 may be a prolate spheroid, an oblate spheroid, a cone, or any other shape.

To calculate the match zone 34 different approaches can be used. In the case of pre-recorded video feeds, commercial video editing software may be used to perform rotoscoping and tracking to determining the match zone 34. In the case of either live or pre-recorded video feeds, computer vision techniques may be used to determine the match zone 34. This generally involves processing the video 30 using edge detection techniques to extract features of the surgical tool 32, followed by machine learning techniques to classify the tool's configuration. Alternatively, maximum likelihood estimators may be used to determine the match zone 34 in real time. Other methods of determining match zone 34 will be apparent to those having skill in the art.

A computer-generated virtual surgical tool (a “CG tool”) 36 is superimposed 109 on the displayed video 30. The CG tool 36 may be generated by the computer 24 of the simulator 10. The CG tool 36 is selectively controlled by the first input device 16 such that movement of the first input device 16 causes a corresponding movement of the CG tool 36 on the display 14. The movement may be “one-to-one” such that a one degree rotation of the first input device 16 causes a one degree rotation of the CG tool 36, or the relation of movement between the first input device 16 and the CG tool 36 may be any other relation. The relation may be chosen to best recreate the feel of the tool being simulated (e.g., a surgical robot).

A target position 38 of the CG tool 36 is determined. The target position 38 of the CG tool 36 corresponds to the determined match zone 34 of the first surgical tool 32. For example, if the match zone 34 of the first surgical tool 32 is a region surrounding a point at the end of the tool 32, the target position 38 of the CG tool 36 is a corresponding point on the virtual tool 36. The target position 38 may be determined in two or three dimensions.

By comparing the determined match zone 34 and target position 38, the computer may determine whether the target position 38 of the CG tool 36 (the CG tool 36 being superimposed on the video 30 of the MIS, which includes the first surgical tool 32) is within the match zone 34 of the first surgical tool 32. As such, the target position 38 and match zone 34 serve as proxies for movement of the respective tools, allowing the computer 24 to determine whether movement of the CG tool 36, caused by an operator using the first input device 16, substantially matches the movement of the first surgical tool 16 in the video 30. Other proxies for tool movement (and other characteristics) are further detailed below.

The intersection of the target position 38 and match zone 34 may be determined by methods known in the art, including, but not limited to: (1) using bounding-sphere collision detection algorithms; (2) determining the minimum Euclidean distance between the CG tool 36 and the target position 38; (3) analyzing the Z buffer of the graphics engine, to determine the depth at which intersection takes place; or (4) using camera based calibration of the apparent and desired, size and configuration of the CG tool 36.

If the movement (e.g., position over time) of the CG tool 36 does not substantially match the movement of the first surgical tool 32, further steps may be taken. In an embodiment according to the present invention, the video 30 may be paused 160. When the video 30 is paused, the instant video frame of the video 30 is displayed on the display 14, but the video 30 is not advanced—so called “freeze frame.” The video 30 may resume when the position of the CG tool 36 is once again determined to substantially match the position of the first surgical tool 32. In this way, if the operator causes the movement of the CG tool 36 to substantially match the movement of the first surgical tool 32, the video 30 will advance without pausing.

In another embodiment, when the movement of the CG 36 tool does not substantially match that of the first surgical tool 32, a message 40 may be displayed on the display 14 stating informing the operator of the unmatched movement. Further, the message 40 may provide detail regarding how the movement is not matched. For example, the message 40 may state “You are too medial.” Alternatively, the simulator 10 may also include a speaker 42, and the computer 24 may cause an audible alert to sound from the speaker 42. The alert may be a tone, a voice giving details (“You are too medial”), or any other audible indication to the operator.

In another embodiment, the first input device 16 may receive a signal from the computer 24 and the first input device 16 may move 190 depending on the signal. In this way, when the movement of the CG tool 36 does not substantially match the movement of the first surgical tool 32, the computer 24 may signal the first input device 16 (and thereby, the CG tool 36) to move 190 to a position where the CG tool 36 does match the first surgical tool 32. In this way, the operator may receive instructive feedback through the first input device 16.

It may be beneficial for the operator to match not only the movement of a point on a surgical tool, but also the orientation of that tool. Movement of the first surgical tool 32 may be further defined to include a position of the trocar for the tool. In MIS, surgical tools enter a patient's body at an entry point through an incision. The motion of the tool is then centered upon this point such that the size of the incision is minimized. This entry point is known as the trocar. A method of the present invention may include the step of calculating 170 the location of the entry point of the first surgical tool. The entry point is not shown in the video 30 (or the figures of this disclosure) because the video 30 is recorded from within a patient's body and, therefore, the entry point behind the camera and out of view.

Methods to calculate the entry point would be similar to those of calculating the match zone 34. In the case of pre-recorded video feeds, commercial video editing software may be used to perform rotoscoping and tracking for determining the entry point. In the case of either live or pre-recorded video feeds, computer vision techniques could be used to determine the entry point. This generally involves processing the video using edge detection techniques to extract features of the surgical tool, followed by machine learning techniques to classify the tool's configuration. Alternatively, maximum likelihood estimators may be used to determine the entry point in real time. Other methods of determining match zone will be apparent to those having skill in the art.

Once the entry point and the position of a point (in the match zone 34) is determined, a vector 48 representing the primary axis of the first surgical tool 32 may be determined 173 in the virtual space. A vector 49 of the CG tool 36 may also be determined 173. These vectors 48, 49 may serve as proxies for tool movement. The previously described actions (e.g., pausing 176 the video, moving the first input device 16) may occur if the movement of the CG tool vector 49 does not match the movement of the first surgical tool vector 48.

One method of performing the vector 48, 49 alignment is by treating the tool as a vector sharing the plane with surgical tool from the video feed. A dot product may be used to compute the relative angle between the vector 49 representing the CG tool 36 and the tracked surgical tool 32. The alignment of the tool may then be performed through rotation about the common normal. For a given tool orientation, the depth of the CG tool 36 location can be estimated through relative camera location, and comparative apparent size of the CG tool 36 and the surgical tool 32. The alignment of the CG tool 36 wrist can be performed through a computation of the spherical angle leading to the desired rotation of the wrist, followed by a projection onto the vector 49 representing the tool stem. Other methods for calculating vector alignment known in the art may be used.

The entry point and vectors 48, 49 may be determined in two or three dimensions as is appropriate for the desired simulation (i.e., stereoscopic).

Many of the surgical tools used in MIS may have end-effectors requiring actuation. For example, an electrocautery instrument may require that a surgeon activate the heating component of the instrument, a scissors instrument may require that a surgeon cause the scissor mechanism to open or close, etc. In another embodiment of the present invention, the first surgical tool 32 may include an end-effector 62 requiring activation. As such, the end-effector 62 may have a “status”—e.g., open, closed, on, off, etc. The CG tool 36 may have a similar end-effector 64 able to be activated by the operator. The operator may, for example, use a component of the first input device 16 (e.g., a pincer grip, a button, etc.) to activate the end-effector 64. Alternatively, the simulator 10 may include one or more interface devices 20 to activate, or change the status of, the end-effector 64. In a non-limiting example, the RoSS™ simulator shown in FIG. 1 comprises foot pedals which may be used as interface devices 20 to, for example, activate the end-effector 64. Other interface devices are known in the art and may be selected to best recreate the feel of the simulated instrument.

A method according to an embodiment of the present invention may cause any of the previously described actions (e.g., pausing 180 the video, moving the first input device) to occur if the status of the end-effector 64 of the CG tool 36 does not match the status of the end-effector 62 the first surgical tool 32. For example, if, during the video 30, the end-effector 62 of the first surgical tool 32 is changed—a scissors is closed—the status of the end-effector 64 of the CG tool 36 should be caused by the operator to change. If not, the video 30 may be paused, until the proper action is taken by the operator. There may be a period of time during which it may be acceptable that the status of the end-effector 64 of the CG tool 36 differs from the status of the end-effector 62 of the first surgical tool 32. For example, if a scissors of the first surgical tool 32 is closed, the operator may have a period of time (e.g., three seconds) before the MIS video is paused. In this way, the status of the two end-effectors 62, 64 (CG tool 36 and first surgical tool 32) are said to “substantially match.”

In another embodiment, the video 30 may be interactive such that the point-of-view of the video may be changed by the operator. For example, the video 30 may utilize technologies such as QuickTime VR. The point-of-view may be moved by the operator using the one or more interface devices 20. The interface device 20 may be used either alone or in conjunction with the first input device 16. In a non-limiting example, the interface device may be a joystick which may cause the point-of-view to be moved. In another example, the interface device 20 may be a foot pedal which is used to signal the computer 24 that the first input device 16 will move the camera. In this way, an operator may use the first input device 16 to move the CG tool 36 while the foot pedal is not depressed, and may use the same first input device 16 to move the point-of-view of the camera when the foot pedal is depressed. Other suitable interface devices 20, e.g., buttons, switches, trackpads, etc., are commonly known and may be used.

In the case where a pre-recorded video is used, a surgeon creating the video 30 may move the camera in various directions in order to capture a larger field-of-view. This larger field-of-view may be then be used to generate the interactive video. For example, by stitching together video and/or pictures taken from several points-of-view, a large field-of-view may be created and used by QuickTime VR to generate an interactive video.

In another embodiment according to the invention, the camera movements of the camera used to capture the video 30 may be tracked. These tracked camera movements may be used to generate prompts 44 for the operator to change the point-of-view of the video 30. For example, an arrow may be displayed on the display to prompt the operator to move the point-of-view in the direction of the arrow. The previously described actions (e.g., pausing 150 the video, moving the first input device) may be taken if the movement of the point-of-view does not substantially match the movement of the camera.

The video 30 may include metadata including information such as, but not limited to, tracked camera movement, surgical tool status information, trocar location, or any other data related to the video, the MIS, the surgical environment, or the like. The metadata may be timed to the video 30. In this way, while the video 30 is advancing (displayed on the display), metadata information may be used to determine, for example, the status of the end-effector 62 of the first surgical tool 32 at a time corresponding to the time of the video 30.

The invention may be embodied as an MIS simulator 10 having a computer 24, a display 14 in communication with the computer 24, and a first input device 16 in communication with the computer 24. The computer 24 is programmed to perform the methods described above. Specifically, the computer 24 is programmed to display a video 30 of an MIS on the display 14 and determine a match zone 34 of a first surgical tool 32 visible in at least a portion of the video 30. The computer 34 is also programmed to display a CG tool 36 on the display 14, the CG tool 36 being superimposed on the video 30. The movement of the CG tool 36 is selectively controlled by the input device 16. The computer 24 is also programmed to determine a target position 38 of the CG tool 36 corresponding to the match zone 34.

A simulator according to another embodiment of the present invention may further include a clutch 22. The computer 24 may be programmed to disconnect the CG tool 36 and the first input device 16 when the clutch 22 is activated, such that movement of the first input device 16 no longer causes a movement of the CG tool 36. In this matter, the position of the first input device 16 relative to the CG tool 36 may be changed by the operator. For example, from time-to-time, the operator may reach a mechanical limit of the first input device 16 (e.g., the device is fully extended), yet still need to move the CG tool 36 in the limited direction. In such a case, the clutch 22 may be activated, the first input device 16 may be moved away from the limit and the clutch 22 may be deactivated. In this manner, the CG tool 36 movement may be continued in the direction otherwise prohibited by the limit of the first input device 16. The clutch 22 may be a foot pedal, a button, a switch, or any other mechanism known in the art (i.e., the one or more interface devices).

In another embodiment according to the present invention, a second surgical tool 52 may be visible in at least a portion of the video 30. A match zone 54 of the second surgical tool 52 may be determined—the second match zone 54—corresponding to a position on the second surgical tool 52.

A second CG tool 56 may be superimposed on the displayed video 30. The CG tool 56 may be generated by the computer 24 of the simulator 10. The second surgical tool 52 may be selectively controlled by the first input device 16, such that the first input device 16 may control either the first CG tool 36 or the second CG tool 56, and control may be switched between the CG tools 36, 56 by the operator. Control may be switched by use of the one or more interface devices 20. Alternatively, a second input device 18 may be provided to selectively control the second CG tool 56.

A target position 58 of the second CG tool 56 is determined—the second target position 58. The second target position 58 of the second CG tool 56 corresponds to the determined second match zone 54 of the second surgical tool 52. In this way, the previously described action may be taken when the movement of the second CG tool 56 does not substantially match the movement of the second surgical tool 52.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of minimally-invasive surgery (“MIS”) training, comprising the steps of:
(a) providing a simulator having a display, a computer, and a first input device;
(b) displaying a video of an MIS on the display, wherein a first surgical tool is visible in at least a portion of the video and a match zone corresponding to a position on the video of the first surgical tool is determined; and
(c) providing a computer-generated virtual surgical tool (“CG tool”) superimposed on the displayed video, wherein the CG tool is selectively controlled by the first input device and wherein a target position on the CG tool corresponding to the match zone is determined.

2. The method of claim 1, wherein the video is a stereoscopic video.

3. The method of claim 2, wherein the match zone and the target position are determined in three-dimensions.

4. The method of claim 1, wherein the video is pre-recorded.

5. The method of claim 4, further comprising the step of pausing the video when the target position of the CG tool is not located within the match zone.

6. The method of claim 4, wherein the video is interactive and point-of-view of the interactive video is moved by way of an interface device.

7. The method of claim 6, wherein a camera movement of a camera used to record the video is pre-determined and a prompt to is displayed on the display to show a required movement of the point-of-view of the interactive video.

8. The method of claim 7, further comprising the step of pausing the video when the movement of the point-of-view of the interactive video does not substantially match the pre-determined movement of the camera.

9. The method of claim 1, wherein the match zone corresponds to the end of the first surgical tool.

10. The method of claim 4, further comprising the step of calculating an entry point of the first surgical tool.

11. The method of claim 10, further comprising the step of calculating a vector of the first surgical tool.

12. The method of claim 11, further comprising the step of pausing the video when the vector of the CG tool does not substantially match the vector of the first surgical tool.

13. The method of claim 12, wherein the vector of the first surgical tool and the vector of the CG tool are determined in three-dimensions.

14. The method of claim 4, wherein each of the first surgical tool and the CG tool further comprises an end-effector.

15. The method of claim 14, further comprising the step of pausing the video when the status of the end-effector of the CG Tool does not substantially match the status of the end-effector of the first surgical tool.

16. The method of claim 1, wherein the first input device is configured to receive signals from the computer to cause the first input device to move.

17. The method of claim 16, further comprising the step of moving the first input device when the target position of the CG tool is not located within the match zone, such that the CG tool is moved into the match zone.

18. The method of claim 1, wherein the video is a live feed from an MIS.

19. A minimally-invasive surgery (“MIS”) simulator, comprising:
(a) a computer;
(b) a display in communication with the computer;
(c) a first input device in communication with the computer;
(d) wherein the computer is programmed to:
(i) display a video of an MIS on the display, wherein a first surgical tool is visible in at least a portion of the video and a match zone corresponding to a position on the video of the first surgical tool is determined; and
(ii) superimpose a computer-generated virtual surgical tool (“CG tool”) on the displayed video, wherein the CG tool is selectively controlled by the first input device and wherein a target position on the CG tool corresponding to the match zone is determined.

20. The MIS simulator of claim 19, further comprising a clutch, and wherein the computer is further programmed to disconnect the CG tool from the first input device when the clutch is activated, so that the first input device can be moved without moving the CG tool.

21. The MIS simulator of claim 19, wherein the video is pre-recorded.

22. The MIS simulator of claim 21, wherein the computer is further programmed to pause the video when the target position of the CG tool is not located within the match zone.

23. The MIS simulator of claim 21, wherein the pre-recorded video further comprises video metadata, and the pre-determined position of the first surgical tool is recorded in the video metadata.

24. The MIS simulator of claim 21, wherein a second surgical tool is visible in at least a portion of the video and a second match zone corresponding to a position on the video of the second surgical tool is pre-determined, and a second CG tool is superimposed on the displayed video, the second CG tool being selectively controlled by the first input device, and wherein a second target position on the CG tool corresponding to the second match zone is pre-determined.

25. The MIS simulator of claim 24, further comprising a second input device and wherein the second CG tool is selectively controlled by the second input device.

26. The MIS simulator of claim 25, wherein the computer is further programmed to pause the video when the second target position of the second CG tool is not located within the second match zone.

27. The MIS simulator of claim 21, wherein the match zone corresponds to the end of the first surgical tool.

28. The MIS simulator of claim 21, wherein the computer is further programmed to calculate an entry point of the first surgical tool.

29. The MIS simulator of claim 23, wherein a position of an entry point of the first surgical tool is pre-calculated, and the pre-calculated position is recorded in the video metadata.

30. The MIS simulator of claim 29, further comprising the step of calculating a vector of the first surgical tool.

31. The MIS simulator of claim 30, wherein the computer is further programmed to pause the video when the vector of the CG tool does not substantially match the vector of the first surgical tool.

32. The MIS simulator of claim 31, wherein the vector of the first surgical tool and the vector of the CG tool are determined in three-dimensions.

33. The MIS simulator of claim 19, wherein the display is a stereoscopic display.

34. The method of claim 19, wherein the first input device is configured to receive signals from the computer to cause the first input device to move.

35. The method of claim 34, further comprising the step of moving the first input device when the target position of the CG tool is not located within the match zone, such that the CG tool is moved into the match zone.

36. The method of claim 19, wherein the video is a live feed from an MIS.
